(19) United States
(12) Patent Application Publication
(10) Pub. No.: US 2015/0363605 A1
(43) Pub. Date: Dec. 17, 2015

(54) RECOGNIZABLY PROTECTING ELECTRONIC FILES

(71) Applicant: Microsoft Corporation, Redmond, WA (US)

(72) Inventor: DANIEL FRANK EDDY PLASTINA, Sammamish, WA (US)

(21) Appl. No.: 14/302,074

(22) Filed: Jun. 11, 2014

(51) Int. Cl. G06F 21/62; G06F 17/30

(52) U.S. Cl. CPC G06F 21/6218; G06F 17/301

(57) ABSTRACT

Systems, methods, and computer-readable storage media are provided for recognizably protecting electronic files, e.g., images. Electronic files are protected through association with permissions that permit or constrain authorized users from performing specifically delineated actions with respect thereto. Upon receiving a request to view a protected file, a low-fidelity artifact of the requested file is provided that is obfuscated to a degree sufficient to jog the memory of a user that has viewed the requested file previously but yet remains sufficiently unrecognizable to a user that has not previously viewed the file. Upon determining that at least one permission associated with the file is satisfied, a high-fidelity artifact of the file is provided that is void of obfuscation. Depending on the nature of the permissions associated with the file, the authorized user may take additional actions (e.g., copying, forwarding, saving, etc.) with respect to the electronic file as well.

### BACKGROUND

Data encryption is often utilized to protect electronic files (e.g., documents and images) from viewing by unauthorized users. Such encryption, however, fails to make such files recognizable to users even subsequent to a file being viewed. When the file is a document (for instance, a WORD document), the file name is sometimes, but not always, sufficient to jog a user's memory as to the contents of the item. However, when the file is, for instance, an image, the file name is often void of any meaning to the user. In fact, image file names are often generated by an image capturing device as a series of random or otherwise seemingly meaningless characters that are not changed by users. Thus, even if a user has viewed a particular image previously, s/he is not able to jog his/her memory simply by reading the file name of an encrypted image.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In various embodiments, systems, methods, and computer-readable storage media are provided for recognizably protecting electronic files. Users are able to protect electronic files (e.g., documents and images) through association with permissions that permit authorized users to perform or not perform specifically delineated actions, including unobstructed viewing, with respect to such files. Upon receiving a request to view a protected file, a low-fidelity artifact of the requested file is provided that is obfuscated to a degree sufficient to jog the memory of a user that has viewed the requested file previously but yet remains sufficiently unrecognizable to a user that has not previously viewed the file. Upon determining that at least one permission associated with the file is satisfied (e.g., upon receiving user credentials and thereby determining that the requesting user is an authorized user), a high-fidelity artifact of the file is provided that is void of obfuscation. Depending on the nature of the permissions associated with the file, the authorized user may take additional actions (e.g., copying, forwarding, saving, etc.) with respect to the electronic file as well.

### BRIEF DESCRIPTION OF THE DRAWINGS

The present invention is illustrated by way of example and not limitation in the accompanying figures in which like reference numerals indicate similar elements and in which:

FIG. 1 is a block diagram of an exemplary computing environment suitable for use in implementing embodiments of the present invention;

FIG. 2 is a block diagram of an exemplary computing system in which embodiments of the invention may be employed to recognizably protect electronic files;

FIG. 3 is a schematic diagram showing exemplary obfuscation of an image file via blurring, in accordance with an embodiment of the present invention;

FIG. 4 is a schematic diagram showing exemplary obfuscation of an image file via masking (removing or covering) a portion thereof, in accordance with an embodiment of the present invention;

FIG. 5 is a schematic diagram showing exemplary obfuscation of an image file via pixilation, in accordance with an embodiment of the present invention;

FIG. 6 is an schematic diagram showing an exemplary screen display associated with an application for recognizably protecting electronic files, in accordance with an embodiment of the present invention;

FIG. 7 is a flow diagram showing an exemplary method for recognizably protecting electronic files, in accordance with an embodiment of the present invention;

FIG. 8 is a flow diagram showing another exemplary method for recognizably protecting electronic files, in accordance with an embodiment of the present invention; and

FIG. 9 is a flow diagram showing yet another exemplary method for recognizably protecting electronic files, in accordance with an embodiment of the present invention.

### DETAILED DESCRIPTION

The subject matter of the present invention is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-readable storage media for recognizably protecting electronic files. Users are able to protect files through association with permissions that permit authorized users to perform or not perform specifically delineated actions with respect to such files. Upon receiving a request to view a protected electronic file, a low-fidelity artifact of the requested file is provided that is obfuscated to a degree sufficient to jog the memory of a user that has viewed the requested file previously but yet remains sufficiently unrecognizable to a user that has not previously viewed the file. Such obfuscation may be achieved, by way of example, by one or more of blurring, pixilation, or masking (that is, removing or covering one or more portions of the file). Upon determining that at least one permission associated with the file is satisfied (e.g., upon determining that the requesting user is an authorized user), a high-fidelity artifact of the file is provided that is void of intentionally added obfuscation. Depending on the nature of the permissions associated with the file, an authorized user may take additional actions (e.g., copying, forwarding, saving, etc.) with respect thereto as well.

Accordingly, one embodiment of the present invention is directed to one or more computer-readable storage media storing computer-useable instructions that, when used by one or more computing devices, cause the one or more computing devices to perform a method for recognizably protecting electronic files. The method includes presenting a low-fidelity artifact associated with an electronic file, the electronic file having at least one permission associated therewith; verifying that the at least one permission has been satisfied; and presenting a high-fidelity artifact associated with the electronic file upon verification.

In another embodiment, the present invention is directed to a method being performed by one or more computing devices including at least one processor, the method for recognizably protecting electronic files. The method includes receiving a high-fidelity artifact associated with an electronic file; receiving an indication to obfuscate at least a portion of the received high-fidelity artifact; obfuscating the indicated portion of the received high-fidelity artifact to create a low-fidelity artifact associated with the electronic file; receiving at least one permission associated with the electronic file, the at least one permission, upon satisfaction thereof, permitting access to the high-fidelity artifact; and storing the high-fidelity artifact, the low-fidelity artifact, and the at least one permission in association with one another.

In yet another embodiment, the present invention is directed to a system including a file protection engine having one or more processors and one or more computer-readable storage media, and a data store coupled with the file protection engine. The file protection engine is configured to receive at least one high-fidelity artifact associated with an electronic file; receive an indication to obfuscate at least a portion of the received high-fidelity artifact; obfuscate the indicated portion of the received high-fidelity artifact to create a low-fidelity artifact associated with the electronic file; and receive at least one permission associated with the electronic file, the at least one permission, upon satisfaction thereof, permitting access to the high-fidelity artifact. The file protection engine further is configured to store the high-fidelity artifact, the low-fidelity artifact, and the at least one permission in association with one another; receive a request to view the electronic file; present the low-fidelity artifact associated with the electronic file; verify that the at least one permission has been satisfied; and present the high-fidelity artifact associated with the electronic file upon verification.

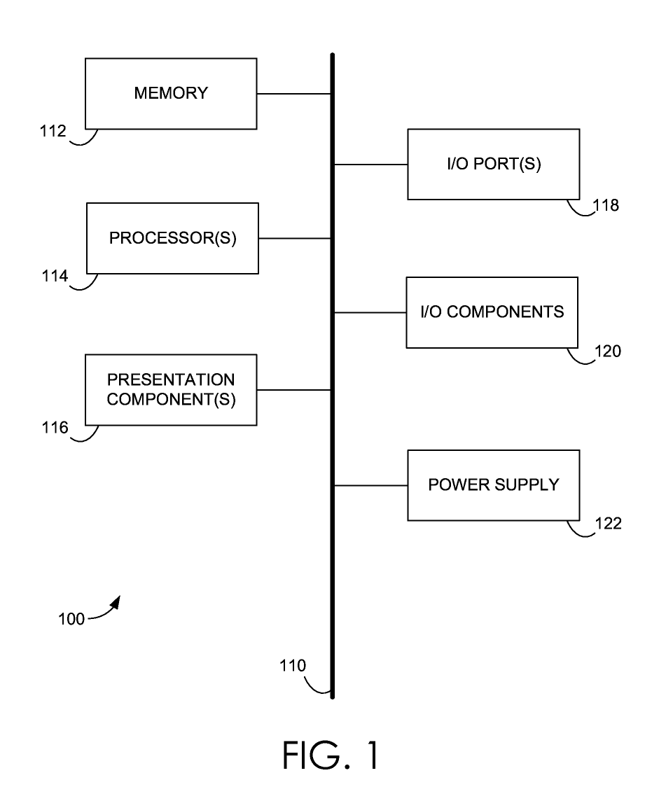

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one component nor any combination of components illustrated.

Embodiments of the invention may be described in the general context of computer code or machine-useable instructions, including computer-useable or computer-executable instructions such as program modules, being executed by a computer or other machine, such as a personal data assistant or other handheld device. Generally, program modules including routines, programs, objects, components, data structures, and the like, and/or refer to code that performs particular tasks or implements particular abstract data types. Embodiments of the invention may be practiced in a variety of system configurations, including hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventor hereof recognizes that such is the nature of the art, and reiterates that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media; computer storage media excluding signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a microphone, joystick, game pad, satellite dish, scanner, printer, wireless device, and the like. Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term “file protection engine” is used herein, it will be recognized that this term may also encompass a server, a Web browser, a set of one or more processes distributed on one or more computers, one or more stand-alone storage devices, a set of one or more other computing or storage devices, a combination of one or more of the above, and the like.

As previously mentioned, embodiments of the present invention are generally directed to systems, methods, and computer-readable storage media for recognizably protecting electronic files. Users are able to protect electronic files through association with permissions that permit authorized users (such authorization itself being a permission) to perform or not perform specifically delineated actions with respect to such files. Upon receiving a request to view a protected file, a low-fidelity artifact of the requested file is provided that is obfuscated (e.g., blurred, pixelated, and/or masked) to a degree sufficient to jog the memory of a user that has viewed the requested file previously but yet remains sufficiently unrecognizable to a user that has not previously viewed the file. Upon determining that at least one permission associated with the file is satisfied (e.g., upon determining that the requesting user is an authorized user), a high-fidelity artifact of the file is provided that is void of obfuscation intended to render the file unrecognizable to those that have not previously viewed the file. Depending on the nature of the permissions associated with the file, the authorized user may take additional actions (e.g., copying, forwarding, saving, etc.) with respect to the electronic file as well.

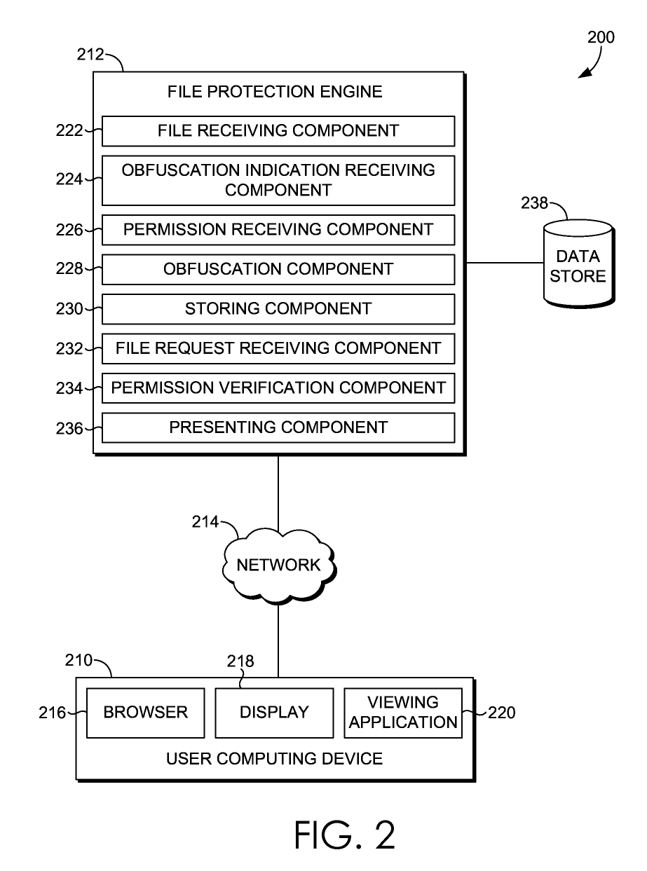

Referring now to FIG. 2, a block diagram is provided illustrating an exemplary computing system 200 in which embodiments of the present invention may be employed. Generally, the computing system 200 illustrates an environment in which electronic files may be protected through association with low-fidelity artifacts and permissions. Among other components not shown, the computing system 200 generally includes a user computing device 210 and a file protection engine 212 in communication with one another via a network 214. The network 214 may include, without limitation, one or more local area networks (LANs) and/or wide area networks (WANs). Such networking environments are commonplace in offices, enterprise-wide computer networks, intranets and the Internet. Accordingly, the network 214 is not further described herein.

It should be understood that any number of user computing devices 210 and/or file protection engines 212 may be employed in the computing system 200 within the scope of embodiments of the present invention. Each may comprise a single device/interface or multiple devices/interfaces cooperating in a distributed environment. For instance, the file protection engine 212 may comprise multiple devices and/or modules arranged in a distributed environment that collectively provide the functionality of the file protection engine 212 described herein. Additionally, other components or modules not shown also may be included within the computing system 200.

In some embodiments, one or more of the illustrated components/modules may be implemented as stand-alone applications. In other embodiments, one or more of the illustrated components/modules may be implemented via the user computing device 210, the file protection engine 212, or as an Internet-based service. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of file protection engines and/or user computing devices. By way of example only, the file protection engine 212 might be provided as a single computing device (as shown), a cluster of computing devices, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The user computing device 210 may include any type of computing device, such as the computing device 100 described with reference to FIG. 1, for example. Generally, the user computing device 210 includes a browser 216, a display 218, and a viewing application 220. The browser 216, among other things, is configured to render electronic files (as low-fidelity artifacts and high-fidelity artifacts, as more fully described below) in association with the display 218 of the user computing device 210. The browser 216 is further configured to receive user input of requests for electronic files and to receive electronic files for presentation on the display 218, for instance, from the file protection engine 212. It should be noted that the functionality described herein as being performed by the browser 216 may be performed by any other application, application software, user interface, or the like capable of rendering electronic file content. It should further be noted that embodiments of the present invention are equally applicable to mobile computing devices and devices accepting touch and/or voice input. Any and all such variations, and any combination thereof, are contemplated to be within the scope of embodiments of the present invention.

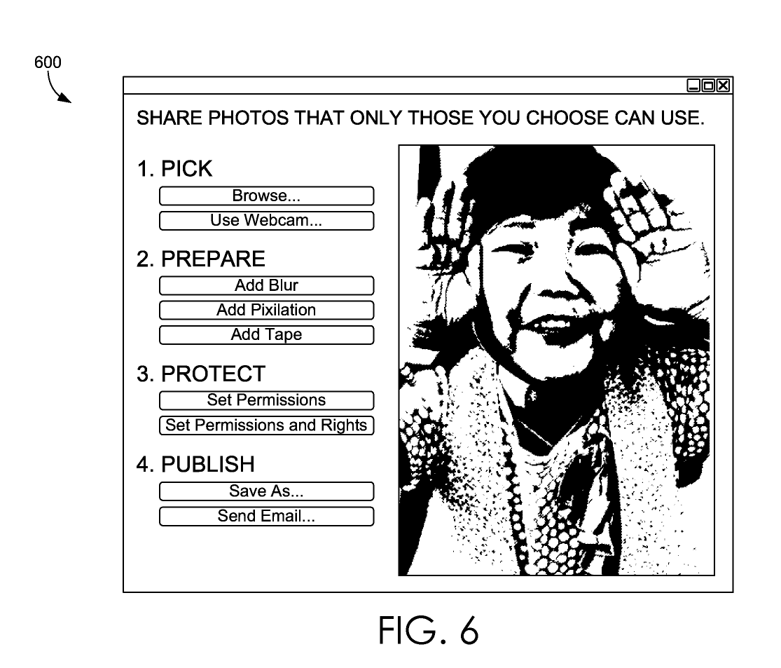

The viewing application 220 of the user computing device 216 is an application configured to permit viewing of low-fidelity artifacts and high-fidelity artifacts associated with electronic files in association with the display 218 of the user computing device 220, depending upon permissions associated with a given file. The viewing application 220 further may be configured to permit and/or constrain actions of certain users and/or with respect to certain files based upon the permissions associated with various files. A schematic diagram showing an exemplary screen display 600 associated with an application for recognizably protecting image files for viewing in association with the viewing application 220, in accordance with an embodiment of the present invention, is more fully described below with reference to FIG. 6. It will be understood and appreciated by those or ordinary skill in the art that while the examples illustrated and described herein relate primarily to image files, such is by way of example only and not intended to limit the scope of embodiments hereof in any way. Rather, any electronic file may be protected in accordance with the systems and methods described herein including, by way of example only, WORD files, EXCEL files, VISIO files, image files, PDF files, and the like.

The file protection engine 212 of FIG. 2 is configured to, among other things, receive requests for presentation of electronic files and provide electronic files (as low-fidelity artifacts and high-fidelity artifacts) in response thereto in accordance with delineated permissions. The file protection engine 212 additionally is configured to, among other things, receive electronic files and permissions associated therewith. As illustrated, the file protection engine 212 includes a file receiving component 222, an obfuscation indication receiving component 224, a permission receiving component 226, an obfuscation component 228, a storing component 230, a file request receiving component 232, a permission verification component 234, and a presenting component 236. The illustrated file protection engine 212 also has access to a data store 238. The data store 238 is configured to store information related to electronic files and their associated permissions. In various embodiments, such information may include, without limitation, authorized user identifications, actions that various authorized users are and are not permitted to perform with respect to certain files, low-fidelity artifacts of files, high-fidelity artifacts of files, and the like. In embodiments, the data store 238 is configured to be searchable for one or more of the items stored in association therewith. It will be understood and appreciated by those of ordinary skill in the art that the information stored in association with the data store 238 may be configurable and may include any information relevant to electronic files and their associated permissions. The content and volume of such information are not intended to limit the scope of embodiments of the present invention in any way. Further, though illustrated as a single, independent component, the data store 238 may, in fact, be a plurality of storage devices, for instance a database cluster, portions of which may reside in association with the file protection engine 212, the user computing device 210, another external computing device (not shown), and/or any combination thereof.

The file receiving component 222 of the file protection engine 212 is configured to receive a high-fidelity artifact associated with an electronic file. A received high-fidelity artifact typically is an electronic file or file portion void of any intentional obfuscation added by a user with the intent to render the file unrecognizable to persons that have not previously viewed the file. In embodiments, a high-fidelity artifact associated with an electronic file is received via an application for recognizably protecting electronic files. A schematic diagram showing an exemplary screen display 600 associated with an application for recognizably protecting image files, in accordance with an embodiment of the present invention, is illustrated with reference to FIG. 6. Images may be selected from an existing image library, for instance, by selection of the “Browse” indicator or captured via an image capture device, for instance, by selection of the “Use Webcam” indicator.

Returning to FIG. 2, the obfuscation indication receiving component 224 of the file protection engine 212 is configured to receive a user indication to obfuscate at least a portion of the high-fidelity artifact. In embodiments, the received indication indicates the type of obfuscation desired. For instance, if file blurring is desired, the “Add Blur” indicator may be selected. If file pixilation is desired, the “Add Pixilation” indicator may be selected. And if masking (e.g., covering or removing) is desired, the “Add Tape” indicator may be selected. In embodiments, upon selection of the type of obfuscation desired, an indication of one or more portions of the file for which obfuscation is desired may also be selected. For instance, in embodiments where obfuscation is desired only for particularly sensitive or identifiable portions of the file, an indication of those desired portions may be indicated by the user and received by the obfuscation indication receiving component 224. Obfuscation indications may be received, by way of example only, via shaking, spinning, or otherwise moving the computing device, or by touches of a presented file being received from a human finger or other stylus-like device. Any and all such variations, and any combination thereof, are contemplated to be within the scope of embodiments of the present invention.

With reference back to FIG. 2, the permission receiving component 226 of the file protection engine 212 is configured to receive at least one permission associated with an electronic file. In embodiments, satisfaction of the at least one permission permits access to a high-fidelity artifact associated with the file, whereas if the at least one permission is not satisfied, access is provided only to the low-fidelity or obfuscated artifact associated with the file, as more fully described below. In embodiments, “permissions” identify individuals authorized to view the high-fidelity artifact. In embodiments, “permissions” further may define additional actions (e.g., copying, forwarding, saving, etc.) that an authorized individual may perform, either as a collective group (that is, actions that may be performed by all authorized individuals) or on an individual authorized user basis. In embodiments, such additional actions may be termed “rights” as opposed to “permissions.” Any and all such variations, and any combination thereof, are contemplated to be within the scope of embodiments of the present invention. With reference back to FIG. 6, permissions and/or rights may be defined and associated with electronic files upon selection of the “Set Permissions” and/or “Set Permissions and Rights” indicators.

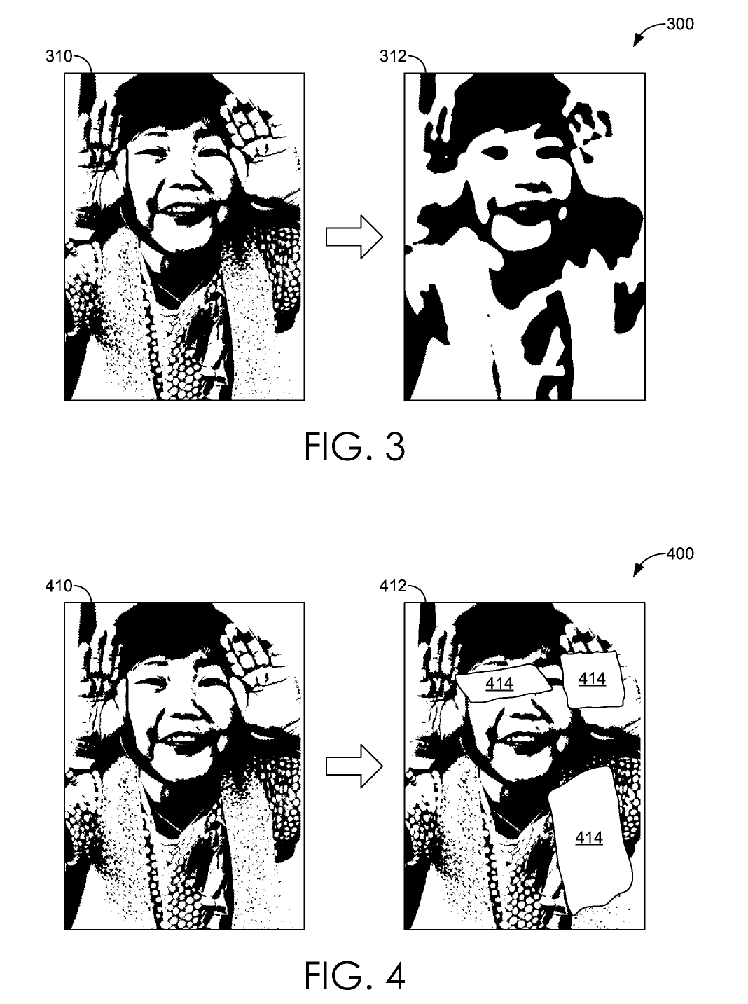

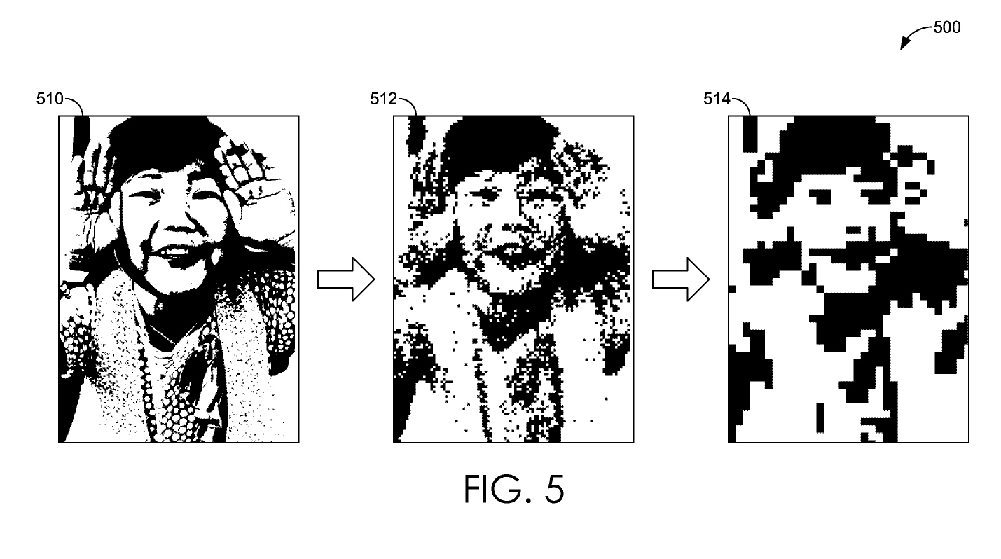

The obfuscation component 228 of the file protection engine 212 is configured to apply obfuscation as indicated to high-fidelity artifacts associated with electronic files to create low-fidelity artifacts associated with the files. Such obfuscation may be, by way of example only, by virtue of blurring, masking (e.g., removing or covering), pixelating, or the like, one or more portions of the high-fidelity artifact. With reference to FIG. 3, a schematic diagram 300 is illustrated showing exemplary obfuscation of a high-fidelity artifact 310 of an image file via blurring to create a low-fidelity artifact 312, in accordance with an embodiment of the present invention. With reference to FIG. 4, a schematic diagram 400 is illustrated showing exemplary obfuscation of a high-fidelity artifact 410 of an image file via masking (removing or covering) portions 414 thereof to create a low-fidelity artifact 412, in accordance with an embodiment of the present invention. With reference to FIG. 5, a schematic diagram 500 is illustrated showing exemplary obfuscation of a high-fidelity artifact 510 of an image file via two different levels of pixilation to create two different low-fidelity artifacts 512, 514, in accordance with an embodiment of the present invention. FIG. 5 illustrates that obfuscation may be applied at differing levels of intensities depending upon how recognizable or unrecognizable the user desires the underlying electronic file to be.

With reference back to FIG. 2, the storing component 230 of the file protection engine 212 is configured to store high-fidelity artifacts, low-fidelity artifacts, and/or permissions/rights in association with one another, for instance, in association with the data store 238.

The file request receiving component 232 is configured to receive requests for viewing of electronic files. Upon receipt of a request to view an electronic file, the low-fidelity artifact (or obfuscated file) may be transmitted, e.g., via the presenting component 236, for viewing in association with the viewing application 220 of the user computing device 210. In embodiments, only after presentation of the low-fidelity artifact, the permission verification component 234 may be configured to verify whether or not a user requesting to view the file is authorized to view the high-fidelity artifact. In other words, the permission verification component 234 may be configured to verify whether there is a permission associated with the electronic file that identifies the user requesting to view the file as an authorized user. In such embodiments, if it is determined by the permission verification component 234 that the user requesting to view the file is authorized to view the high-fidelity artifact (that is, that there is a permission associated with the electronic file that identifies the user requesting to view the file as an authorized user), the low-fidelity artifact may be replaced with the high-fidelity or non-obfuscated file for presentation (e.g., via the presenting component 236). If, however, it is determined by the permission verification component 234 that the user requesting to view the electronic file is not authorized to view the high-fidelity artifact (that is, that there is not a permission associated with the file that identifies the user requesting to view the file as an authorized user), the low-fidelity or obfuscated artifact may remain.

In embodiments, the permission verification component 234 may determine whether the user requesting to view the electronic file is an authorized user prior to the presenting component 236 transmitting any artifact of the file at all for presentation in association with the viewing application 220. In such embodiments, if the user is determined by the permission verification component 234 to be an authorized user (that is, if it determined by the permission verification component 234 that there is a permission associated with the electronic file that identifies the user requesting to view the file as an authorized user), the presenting component 236 may be configured to transmit the high-fidelity artifact for viewing in association with the viewing application 220. If, however, the user is determined by the permission verification component 234 to not be an authorized user (that is, if it is determined by the permission verification component 234 that there is not a permission associated with the electronic file that identifies the user requesting to view the file as an authorized user), the presenting component 236 may be configured to transmit the low-fidelity artifact for viewing in association with the viewing application 220. In embodiments, the permission verification component 234 further is configured to receive indications of additional actions (e.g., copying, forwarding, saving, etc.) that an authorized individual may perform, either as a collective group (that is, actions that may be performed by all authorized individuals) or on an individual authorized user basis.

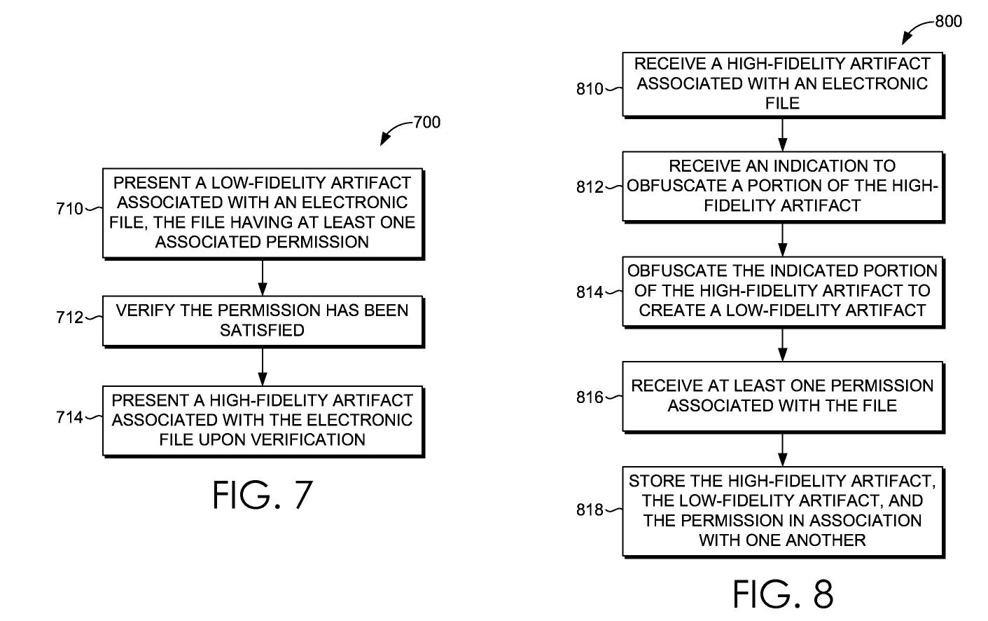

Turning now to FIG. 7, a flow diagram is illustrated showing an exemplary method 700 for recognizably protecting electronic files, in accordance with an embodiment of the present invention. As indicated at block 710, a low-fidelity artifact associated with an electronic file is presented (for instance, utilizing the presenting component 236 of the file protection engine 212 in association with the display 218 of the user computing device 210 of the computing system 200 of FIG. 2), the file having at least one permission associated therewith. In embodiments, the low-fidelity artifact is obfuscated to a degree sufficient to jog the memory of a user that has viewed the file previously but yet remains sufficiently unrecognizable to a user that has not previously viewed the file. In embodiments, the at least one permission may include, by way of example only, an identity associated with an authorized user and/or one or more actions such authorized user may or may not be permitted to perform with respect to the electronic file.

As indicated at block 712, the method 700 further includes verifying (e.g., utilizing the permission verification component 234 of the file protection engine 212 of FIG. 2) that the at least one permission has been satisfied. Upon verification of the at least one permission, a high-fidelity artifact associated with the electronic file, e.g., an artifact of the file void of any obfuscation, is presented (for instance, utilizing the presenting component 236 of the file protection engine 212 in association with the display 218 of the user computing device 210 of the computing system 200 of FIG. 2). This is indicated at block 714.

With reference now to FIG. 8, a flow diagram is illustrated showing another exemplary method 800 for recognizably protecting electronic files, in accordance with an embodiment of the present invention. As indicated at block 810, a high-fidelity artifact associated with an electronic file is received (for instance, by the file receiving component 222 of the file protection engine 212 of the system 200 of FIG. 2). As indicated at block 812, an indication to obfuscate at least a portion of the received high-fidelity artifact is received, e.g., utilizing the obfuscation indication receiving component 224 of the file protection engine 212 of FIG. 2. The indicated portion of the received high-fidelity artifact is obfuscated to create a low-fidelity artifact associated with the electronic file (e.g., utilizing the obfuscation component 228 of the file protection engine 212 of FIG. 2), as indicated at block 814. Also received (for instance, by the permission receiving component 226 of the file protection engine 212 of FIG. 2) is at least one permission associated with the electronic file. This is indicated at block 816. In embodiments, the at least one permission may include, by way of example only, an identity associated with an authorized user and/or one or more actions such authorized user may or may not be permitted to perform with respect to the electronic file. Upon satisfaction of the at least one permission, access is permitted to the high-fidelity artifact, as more fully described herein above. As indicated at block 818, the high-fidelity artifact, the low-fidelity artifact, and the at least one permission are stored in association with one another (for instance, utilizing the storing component 230 of the file protection engine 212 of FIG. 2).

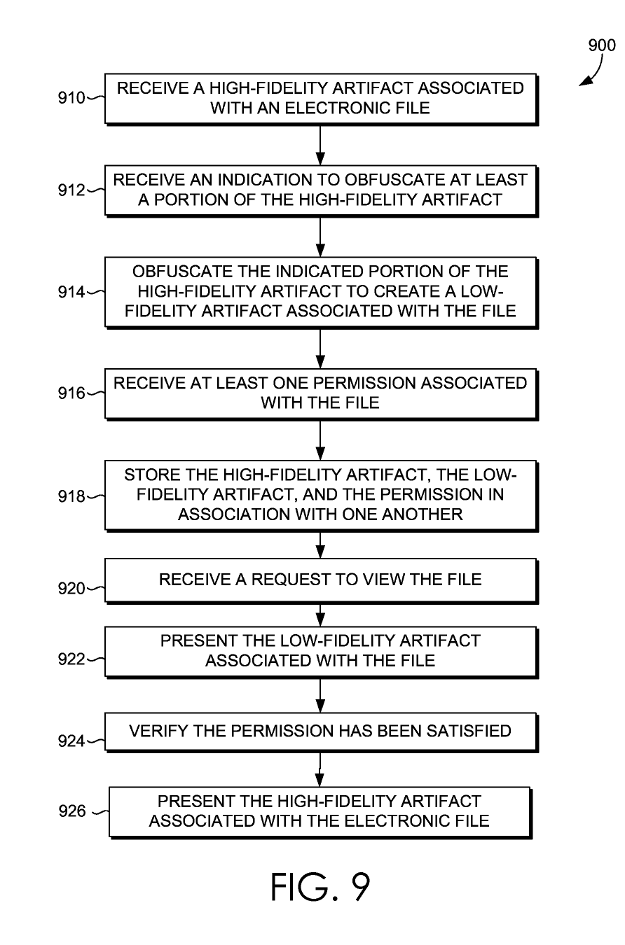

Turning to FIG. 9, a flow diagram is illustrated showing yet another exemplary method 900 for recognizably protecting electronic files, in accordance with an embodiment of the present invention. As indicated at block 910, a high-fidelity artifact associated with an electronic file is received (for instance, by the file receiving component 222 of the file protection engine 212 of the system 200 of FIG. 2). As indicated at block 912, an indication to obfuscate at least a portion of the received high-fidelity artifact is received, e.g., via the obfuscation indication receiving component 224 of the file protection engine 212 of FIG. 2. The indicated portion of the received high-fidelity artifact is obfuscated to create a low-fidelity artifact associated with the electronic file (e.g., utilizing the obfuscation component 228 of the file protection engine 212 of FIG. 2), as indicated at block 914. Also received (for instance, by the permission receiving component 226 of the file protection engine 212 of FIG. 2) is at least one permission associated with the file. This is indicated at block 916. In embodiments, the at least one permission may include, by way of example only, an identity associated with an authorized user and/or one or more actions such authorized user may or may not be permitted to perform with respect to the electronic file. Upon satisfaction of the at least one permission, access is permitted to the high-fidelity artifact, as more fully described herein above. As indicated at block 918, the high-fidelity artifact, the low-fidelity artifact, and the at least one permission are stored in association with one another (for instance, utilizing the storing component 230 of the file protection engine 212 of FIG. 2).

With continued reference to FIG. 9, a request to view the electronic file is received, for instance, by the file request receiving component 232 of the file protection engine 212 of FIG. 2. This is indicated at block 920. As indicated at block 922, the low-fidelity artifact associated with the electronic file is presented (e.g., utilizing the presenting component 236 of the file protection engine 212 of FIG. 2). As indicated at block 924, it is verified that the at least one permission has been satisfied (e.g., by the permission verification component 234 of the file protection engine 212 of FIG. 2) and, upon verification, the high-fidelity artifact associated with the file is presented (e.g., utilizing the presenting component 236 of the file protection engine 212 of FIG. 2), as indicated at block 926.

As can be understood, embodiments of the present invention provide systems, methods, and computer-readable storage media for, among other things, recognizably protecting electronic files. Users are able to protect files through association with permissions that permit authorized users to perform or not perform specifically delineated actions with respect thereto. Upon receiving a request to view a protected file, a low-fidelity artifact of the requested file is provided that is obfuscated to a degree sufficient to jog the memory of a user that has viewed the requested file previously but yet remains sufficiently unrecognizable to a user that has not previously viewed the file. Upon determining that at least one permission associated with the file is satisfied (e.g., upon determining that the requesting user is an authorized user), a high-fidelity artifact of the file is provided that is void of obfuscation. Depending on the nature of the permissions associated with the file, the authorized user may take additional actions (e.g., copying, forwarding, saving, etc.) with respect to the electronic file as well.

The present invention has been described in relation to particular embodiments, which are intended in all respects to be illustrative rather than restrictive. Alternative embodiments will become apparent to those of ordinary skill in the art to which the present invention pertains without departing from its scope.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the methods 700 of FIG. 7, 800 of FIGS. 8, and 900 of FIG. 9 is not meant to limit the scope of the present invention in any way and, in fact, the steps may occur in a variety of different sequences within embodiments hereof. Any and all such variations, and any combination thereof, are contemplated to be within the scope of embodiments of the present invention.

1. One or more computer-readable storage media storing computer-useable instructions that, when used by one or more computing devices, cause the one or more computing devices to perform a method for recognizably protecting electronic files, the method comprising:
presenting a low-fidelity artifact associated with an electronic file, the electronic file having at least one permission associated therewith;
verifying that the at least one permission has been satisfied; and
presenting a high-fidelity artifact associated with the electronic file upon verification.

2. The one or more computer-readable storage media of claim 1, wherein the low-fidelity artifact includes obfuscation of at least one region of the associated electronic file.

3. The one or more computer-readable storage media of claim 2, wherein the obfuscation comprises a blurring of the at least one region of the associated electronic file.

4. The one or more computer-readable storage media of claim 2, wherein the obfuscation comprises pixilation of the at least one region of the associated electronic file.

5. The one or more computer-readable storage media of claim 2, wherein the obfuscation comprises masking of the at least one region of the associated electronic file.

6. The one or more computer-readable storage media of claim 1, wherein the at least one permission includes at least one authorized user identification.

7. The one or more computer-readable storage media of claim 6, wherein the at least one permission further includes a set of rights associated with the at least one authorized user identification.

8. The one or more computer-readable storage media of claim 7, wherein the set of rights constrains at least one action in which the user associated with the at least one authorized user identification is permitted to engage.

9. The one or more computer-readable storage media of claim 8, wherein the at least one action is one of printing the high-fidelity artifact, copying the high-fidelity artifact, saving the high-fidelity artifact, and forwarding the high-fidelity artifact.

10. A method being performed by one or more computing devices including at least one processor, the method for recognizably protecting electronic files, the method comprising:
receiving a high-fidelity artifact associated with an electronic file;
receiving an indication to obfuscate at least a portion of the received high-fidelity artifact;
obfuscating the indicated portion of the received high-fidelity artifact to create a low-fidelity artifact associated with the electronic file;
receiving at least one permission associated with the electronic file, the at least one permission, upon satisfaction thereof, permitting access to the high-fidelity artifact; and
storing the high-fidelity artifact, the low-fidelity artifact, and the at least one permission in association with one another.

11. The method of claim 10, wherein obfuscating the indicated portion of the received high-fidelity artifact comprises blurring the indicated portion of the high-fidelity artifact to create the low-fidelity artifact.

12. The method of claim 11, wherein receiving the indication to obfuscate the portion of the received high-fidelity artifact comprises receiving a shaking motion of a device from which the high-fidelity artifact associated with the electronic file is received.

13. The method of claim 10, wherein obfuscating the indicated portion of the received high-fidelity artifact comprises pixelating the indicated portion of the high-fidelity artifact to create the low-fidelity artifact.

14. The method of claim 10, wherein obfuscating the indicated portion of the received high-fidelity artifact comprises masking the indicated portion of the high-fidelity artifact to create the low-fidelity artifact.

15. The method of claim 10, further comprising:
receiving a request to view the electronic file; and
providing the low-fidelity artifact for viewing.

16. The method of claim 15, further comprising:
receiving authorization credentials;
determining that the at least one permission is satisfied by the authorization credentials; and
providing the high-fidelity artifact for viewing.

17. A system comprising:
a file protection engine having one or more processors and one or more computer-readable storage media; and
a data store coupled with the file protection engine,
wherein the file protection engine:
receives at least one high-fidelity artifact associated with an electronic file;
receives an indication to obfuscate at least a portion of the received high-fidelity artifact;
obfuscates the indicated portion of the received high-fidelity artifact to create a low-fidelity artifact associated with the electronic file;
receives at least one permission associated with the electronic file, the at least one permission, upon satisfaction thereof, permitting access to the high-fidelity artifact;
stores the high-fidelity artifact, the low-fidelity artifact, and the at least one permission in association with one another;
receives a request to view the electronic file;
presents the low-fidelity artifact associated with the electronic file;
verifies that the at least one permission has been satisfied; and
presents the high-fidelity artifact associated with the electronic file upon verification.

18. The system of claim 17, wherein the file protection engine obfuscates the indicated portion of the received high-fidelity artifact by blurring the indicated portion of the high-fidelity artifact to create the low-fidelity artifact.

19. The system of claim 17, wherein the file protection engine obfuscates the indicated portion of the received high-fidelity artifact by pixelating the indicated portion of the high-fidelity artifact to create the low-fidelity artifact.

20. The system of claim 10, wherein the file protection engine obfuscates the indicated portion of the received high-fidelity artifact by masking the indicated portion of the high-fidelity artifact to create the low-fidelity artifact.
